(19) United States
(12) Patent Application Publication
(10) Pub. No.: US 2013/0264879 A1
(43) Pub. Date: Oct. 10, 2013

(54) LOW POWER CONSUMPTION BACKUP POWER SYSTEM

(71) Applicants: Tsun-Te SHIH, New Taipei City (TW); Yu-Yuan CHANG, New Taipei City (TW); Kuang-Lung SHIH, New Taipei City (TW); Po-Wen HSIAO, New Taipei City (TW)

(72) Inventors: Tsun-Te SHIH, New Taipei City (TW); Yu-Yuan CHANG, New Taipei City (TW); Kuang-Lung SHIH, New Taipei City (TW); Po-Wen HSIAO, New Taipei City (TW)

(21) Appl. No.: 13/439,076

(22) Filed: Apr. 4, 2012

(51) Int. Cl. H02J 9/00

(52) U.S. Cl. 307/66; 307/64

(57) ABSTRACT

A low power consumption backup power system includes a power conversion unit connected to an external power input source to generate a converted power, a first power supply circuit and a second power supply circuit electrically connected to the power conversion unit, and a power source switch circuit connected to the first and second power supply circuits. The first power supply circuit receives the converted power and outputs a first output power. The second power supply circuit includes an energy storage unit to store the converted power charged through a charge unit and output the second output power. The power source switch circuit determines to directly output the first output power through the first power supply circuit or output the second output power from the energy storage unit of the second power supply circuit according to whether the converted power is received from the power conversion unit.

### FIELD OF THE INVENTION

The present invention relates to a backup power system and particularly to a low power consumption backup power system.

### BACKGROUND OF THE INVENTION

Because stable electric power is required for operation of most electronic equipment, a power supply is needed to provide the stable power to drive the electronic equipment. Most power supplies are connected to an input source to get an input power and have a power conversion unit to convert the input power into a driving power sent to a load. Such the conventional architecture often has merely one input source to provide the input power, and the input source could be the commercial power source or another power supply. In the event that malfunction occurs to the commercial power source or another power supply, or power drop takes place to interrupt or shut down the electronic equipment, or the power supply driving the electronic equipment is damaged due to overload of a boost unit, to prevent the problem caused by malfunction of a single input source, an Uninterrupted Power System (UPS) has been proposed to connect to the power supply. In the event that the input source malfunctions, the Uninterrupted Power System (UPS) still provides temporarily the stable power to drive the electronic equipment to reduce the risk of abrupt loss of the input power.

The conventional power supply equipped with UPS, referring to FIG. 1, receives an AC power from a commercial power source 1 in normal conditions. The AC power from the commercial power source 1 is in a sinusoidal waveform and passes through a filter 2, an AC/DC converter 3 and a DC/AC converter 4 to generate an AC power in a square waveform sent to a power supply 5 at the rear end. The UPS is coupled with the above-mentioned power supply circuit in parallel, and in a normal power supply condition, it also gets the AC power generated from the commercial power source 1. The AC power is converted into the DC power through a battery charger 6 and stored in a battery module 7. In the event that the commercial power source 1 cannot provide the AC power normally, a switch 8 located between the AC/DC converter 3 and DC/AC converter 4 can be controlled to allow the DC/AC converter 4 to receive the DC power stored in the battery module 7, and also generate AC power in the square waveform to supply for the power supply at the rear end. Under such circuit architecture, whether in the normal power supply condition or via the UPS, multiple times of AC and DC power conversion are needed all that result in great power loss.

### SUMMARY OF THE INVENTION

The primary object of the present invention is to solve the power loss problem caused by multiple times of power conversion in the conventional power supply equipped with UPS.

To achieve the foregoing object, the present invention provides a low power consumption backup power system that is electrically connected to an external power input source and includes a power conversion unit connected to the external power input source to receive an external power and generate a converted power, a first power supply circuit and a second power supply circuit electrically connected to the power conversion unit, and a power source switch circuit connected to the first power supply circuit and second power supply circuit. The first power supply circuit receives the converted power and outputs a first output power. The second power supply circuit is coupled with the first power supply circuit in parallel and includes a charge unit to receive the converted power and an energy storage unit electrically connected to the charge unit. The energy storage unit stores the converted power charged through the charge unit and outputs a second output power. The power source switch circuit includes a first switch located on the first power supply circuit and a second switch located on the second power supply circuit. The power source switch circuit determines to directly output the first output power through the first power supply circuit according to receiving of the converted power from the power conversion unit. In the event that the power source switch circuit cannot get the converted power normally, the power source switch circuit determines to output the second output power from the energy storage unit of the second power supply circuit.

In one embodiment the power source switch circuit includes a voltage detection unit electrically connected to the power conversion unit to judge whether the converted power is output from the power conversion unit. The voltage detection unit generates a first switch signal to control ON of the first switch to allow the first output power to pass through and a second switch signal to control ON of the second switch to allow the second output power to pass through.

In another embodiment the voltage detection unit includes a first control unit connected to the first switch to generate the first switch signal sent to the first switch while detecting the converted power generated by the power conversion unit.

In yet another embodiment the voltage detection unit includes a second control unit connected to the second switch. The second control unit includes a voltage division circuit and a comparison circuit connected to the voltage division circuit. The voltage division circuit gets the converted power from the power conversion unit and divides voltage of the converted power to output a detection voltage to the comparison circuit. The comparison circuit compares the detection voltage with a preset reference voltage to determine whether to generate the second switch signal to control ON/OFF of the second switch.

In yet another embodiment the voltage division circuit includes a first resistor and a second resistor, and regulates the detection voltage sent to the comparison circuit according to the resistance ratio of the first resistor and second resistor.

In yet another embodiment the low power consumption backup power system further includes a boost circuit connected to the first power supply circuit and second power supply circuit. The boost circuit includes a charge/discharge circuit to get the first output power or second output power, a boost switch connected to the charge/discharge circuit, a boost control unit to determine ON period of the boost switch to control charge timing of the second output power to the charge/discharge circuit in order to generate a boost power, and a power output terminal to output the first output power or boost power.

In yet another embodiment the boost power has a voltage equal to that of the first output power.

In yet another embodiment the boost circuit includes a control switch located between the charge/discharge circuit and power output terminal and electrically connected to the boost control unit.

In yet another embodiment the boost control unit gets a detection signal from the first power supply circuit to control ON/OFF of the boost switch and control switch, and determine whether to allow the first output power to directly pass through the boost circuit and output via the power output terminal, or allow the second output power to be boosted via the charge/discharge circuit to become the boost power and output via the power output terminal.

In yet another embodiment the charge/discharge circuit includes an energy storage inductor, a diode and an energy storage capacitor.

In yet another embodiment the voltage of the first output power is higher than the second output power.

In yet another aspect the converted power of the power conversion unit is DC power.

In yet another embodiment the power conversion unit includes a rectification filter unit connected to the external power input source, a power factor correction unit connected to the rectification filter unit, a transformer, a pulse width control unit, a switch element and a rectification output unit.

In yet another embodiment the energy storage unit is a charge battery.

The low power consumption backup power system of the invention mainly has a UPS installed at the rear end of the power conversion unit. In a normal power supply condition, the converted power generated by the power conversion unit is directly output to electronic equipment or loads. In the event that the power conversion unit is abnormal and cannot generate the converted power, the energy storage unit of the second power supply circuit outputs the stored DC power to the electronic equipment. Thus no conversion of AC power and DC power is required in any conditions, and power loss caused by operation of the power supply equipped with the conventional UPS can be greatly reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the power supply circuit structure of a conventional UPS system.

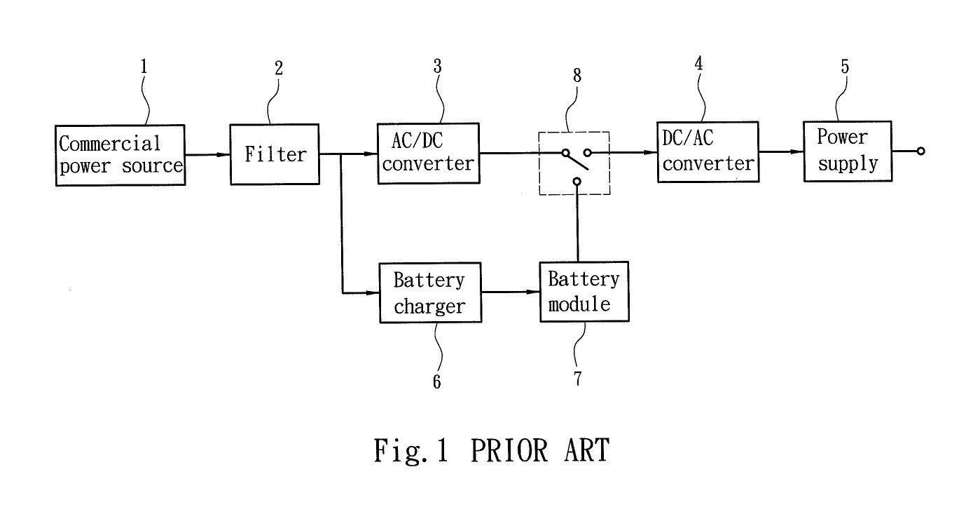

FIG. 2 is a schematic view of the fundamental circuit structure of an embodiment of the invention.

FIG. 3 is a detailed circuit diagram of an embodiment of the invention.

### DETAILED DESCRIPTION OF THE PREFERRED EMBODIMENTS

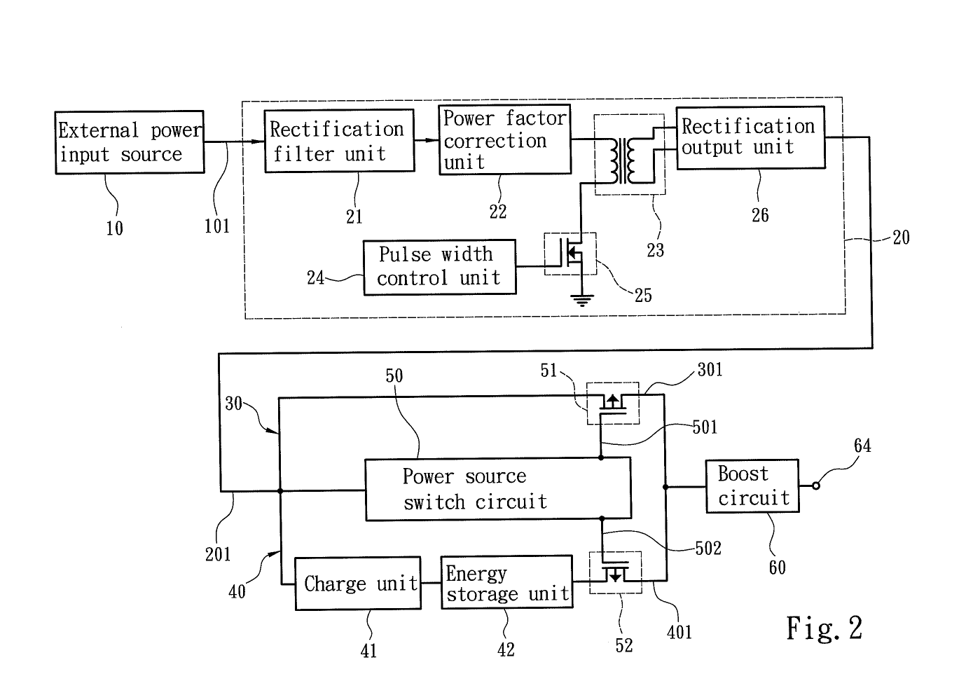

Please refer to FIG. 2 for a schematic view of the fundamental circuit structure of an embodiment of the invention. The low power consumption backup power system of the invention is electrically connected to an external power input source 10 and includes a power conversion unit 20 connected to the external power input source 10 to receive an external power 101 and generate a converted power 201, a first power supply circuit 30 and a second power supply circuit 40 electrically connected to the power conversion unit 20, and a power source switch circuit 50 connected to the first power supply circuit 30 and second power supply circuit 40. In this embodiment, the power conversion unit 20 includes a rectification filter unit 21 connected to the external power input source 10, a power factor correction unit 22 connected to the rectification filter unit 21, a transformer 23, a pulse width control unit 24, a switch element 25 and a rectification output unit 26. The external power 101 from the external power input source 10 is an AC power which passes through the rectification filter unit 21 and power factor correction unit 22. The power factor correction unit 22 regulates the power factor and voltage of the external power 101 through an internal transformed voltage level. The pulse width control unit 24 determines the duty cycle of the switch element 25 to regulate coil current passing through the transformer 23. Finally, the rectification output unit 26 generates the converted power 201 which is DC power. The first power supply circuit 30 receives the converted power 201 from the power conversion unit 20 and outputs a first output power 301. The second power supply circuit 40 is coupled with the first power supply circuit 30 in parallel and includes a charge unit 41 to receive the converted power 201 and an energy storage unit 42 electrically connected to the charge unit 41. The charge unit 41 receives the converted power 201 which passes through an internal rectification filter circuit (not shown in the drawings) and charges in the energy storage unit 42 which in turn outputs a second output power 401. In this embodiment, the energy storage unit 42 is a rechargeable battery.

The power source switch circuit 50 includes a first switch 51 located on the first power supply circuit 30 and a second switch 52 located on the second power supply circuit 40. The power source switch circuit 50 determines to directly output the first output power 301 through the first power supply circuit 30 according to receiving of the converted power 201 from the power conversion unit 20. In the event that the power source switch circuit 50 cannot get the converted power 201 normally, the power source switch circuit 50 determines to output the second output power 401 from the energy storage unit 42 of the second power supply circuit 40.

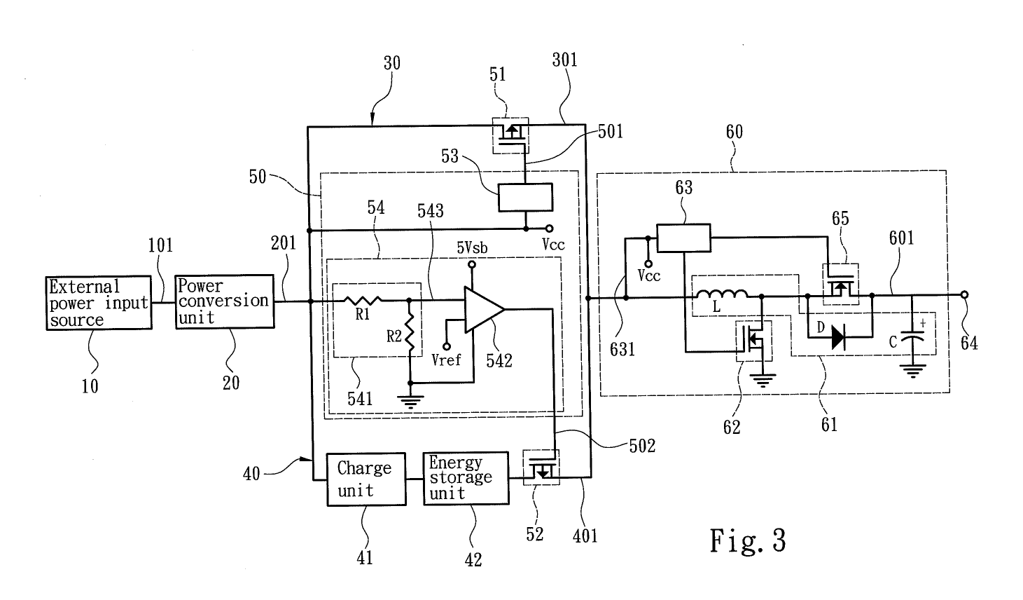

Please refer to FIG. 3 for the detailed circuit structure of an embodiment of the invention. The power source switch circuit 50 includes a voltage detection unit electrically connected to the power conversion unit 20 to judge whether the converted power 201 is output from the power conversion unit 20. The voltage detection unit generates a first switch signal 501 to control ON of the first switch 51 to allow the first output power 301 to pass through and a second switch signal 502 to control ON of the second switch 52 to allow the second output power 401 to pass through. The voltage detection unit includes a first control unit 53 connected to the first switch 51 and a second control unit 54 connected to the second switch 52. The first control unit 53 generates the first switch signal 501 sent to the first switch 51 while detecting the converted power 201 generated by the power conversion unit 20. The second control unit 54 includes a voltage division circuit 541 and a comparison circuit 542 connected to the voltage division circuit 541. The voltage division circuit 541 has a first resistor R1 and a second resistor R2, and gets the converted power 201 from the power conversion unit 20 and regulates a detection voltage 543 sent to the comparison circuit 542 according to the resistance ratio of the first resistor R1 and second resistor R2. The comparison circuit 542 compares the detection voltage 543 with a preset reference voltage Vref to determine whether to generate the second switch signal 502 to control ON/OFF of the second switch 52.

When the power conversion unit 20 supplies power in a normal condition, the first control unit 53 detects the converted power 201 and controls the first switch 51 to turn on. The voltage division circuit 541 of the second control unit 54 divides voltage of the converted power 201 to generate the detection voltage 543 at a level greater than the reference voltage Vref, hence the comparison circuit 542 does not generate the second switch signal 502 and the second switch 52 remains OFF. As a result, the converted power 201 passes through the first power supply circuit 30 which directly outputs the first output power 301. In the event that power supply from the power conversion unit 20 is abnormal, the first detection unit 53 cannot get the converted power 201 and does not output the first switch signal 501 so that the first switch 51 is in an OFF condition; meanwhile, as the voltage division circuit 541 of the second control unit 54 loses the converted power 201 and the detection voltage 543 is smaller than the reference voltage Vref, the comparison circuit 542 generates the second switch signal 502 to the second switch 52 to turn it on. Hence, even if the power conversion unit 20 does not generate the converted power 201, the energy storage unit 42 of the second power supply circuit 40 can output the stored DC power, i.e. the second output power 401. Therefore, whether the power conversion unit 20 is operated in the normal condition or not, by regulating and controlling the first power supply circuit 30 and second power supply circuit 40, the first output power 301 or second output power 401 can be provided.

In this embodiment the voltage of the first output power 301 is not equal to that of the second output power 401. Take an example in which the first output power 301 is at a voltage higher than that of the second output power 401, to maintain the voltage of the electronic equipment at the rear end, the backup power system of the invention further includes a boost circuit 60 connected to the first power supply circuit 30 and second power supply circuit 40 as shown in FIG. 3. The boost circuit 60 includes a charge/discharge circuit 61 to get the first output power 301 or second output power 401, a boost switch 62 connected to the charge/discharge circuit 61, a boost control unit 63 to determine ON period of the boost switch 62 to control charge timing of the second output power 401 to the charge/discharge circuit 61 in order to generate a boost power 601, and a power output terminal 64 to output the first output power 301 or boost power 601. The charge/discharge circuit 61 includes an energy storage inductor L, a diode D and an energy storage capacitor C. The charge/discharge circuit 61 and power output terminal 64 are bridged by a control switch 65 which is coupled with the diode D in parallel and connected electrically to the boost control unit 63. The boost control unit 63 gets a detection signal 631 from the first power supply circuit 30 to control ON/OFF of the boost switch 62 and control switch 65, and determine whether to allow the first output power 301 to directly pass through the boost circuit 60 and output via the power output terminal 64, or allow the second output power 401 to be boosted via the charge/discharge circuit 61 to become the boost power 601 and output through the power output terminal 64. The voltage of the boost power 601 is equal to that of the first output power 301.

In the event that the boost circuit 60 gets the first output power 301 from the first power supply circuit 30, the boost control unit 63 generates the corresponding detection signal 631 and sets the boost switch 62 OFF and the control switch 65 ON, so that the first output power 301 directly passes through the control switch 65 and outputs via the power output terminal 64. In the event that the boost circuit 60 gets the second output power 401 from the second power supply circuit 40 at a voltage lower than that of the first output power 301, the boost control unit 63 generates another corresponding detection signal 631 and sets the boost switch 62 and control switch 65 ON and OFF at the same time in one ON period, so that the charge/discharge circuit 61 charges or discharges the second output power 401 and boosts the second output power 401 to become the boost power 601 at a level the same as that of the first output power 301, and then the boost power 601 is output via the power output terminal 64.

As a conclusion, the low power consumption backup power system of the invention places the UPS at the rear end of the power conversion unit. In the normal power supply condition, the power conversion unit generates the converted power to directly output to electronic equipment or loads almost without any power loss. In the event that the power conversion unit is abnormal and cannot generate the converted power, the energy storage unit of the second power supply circuit outputs the stored DC power, and then the DC power is boosted through a boost circuit to the ordinary working voltage to be used by the electronic equipment. Thus, there is no AC and DC conversion in any conditions, and the power loss caused by operation of power supply equipped with the conventional UPS can be greatly reduced. It provides significant improvements over the conventional techniques.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A low power consumption backup power system electrically connected to an external power input source, comprising:
a power conversion unit connected to the external power input source to receive an external power and generate a converted power;
a first power supply circuit electrically connected to the power conversion unit to receive the converted power and output a first output power;
a second power supply circuit which is electrically connected to the power conversion unit and coupled with the first power supply circuit in parallel, and includes a charge unit to get the converted power and an energy storage unit electrically connected to the charge unit to store the converted power charged through the charge unit and output a second output power; and
a power source switch circuit including a first switch located on the first power supply circuit and a second switch located on the second power supply circuit, the power source switch circuit determining to directly output the first output power through the first power supply circuit according to receiving of the converted power from the power conversion unit, or determining to output the second output power from the energy storage unit of the second power supply circuit in the event that no converted power is received.

2. The low power consumption backup power system of claim 1, wherein the power source switch circuit includes a voltage detection unit electrically connected to the power conversion unit to judge whether the converted power is output from the power conversion unit, the voltage detection unit generating a first switch signal to control ON of the first switch to allow the first output power to pass through and a second switch signal to control ON of the second switch to allow the second output power to pass through.

3. The low power consumption backup power system of claim 2, wherein the voltage detection unit includes a first control unit connected to the first switch to generate the first switch signal sent to the first switch while detecting the converted power generated by the power conversion unit.

4. The low power consumption backup power system of claim 2, wherein the voltage detection unit includes a second control unit connected to the second switch, the second control unit including a voltage division circuit and a comparison circuit connected to the voltage division circuit, the voltage division circuit receiving the converted power from the power conversion unit and dividing voltage of the converted power to output a detection voltage to the comparison circuit; the comparison circuit comparing the detection voltage with a preset reference voltage to determine whether to generate the second switch signal to control ON/OFF of the second switch.

5. The low power consumption backup power system of claim 4, wherein the voltage division circuit includes a first resistor and a second resistor, and regulates the detection voltage sent to the comparison circuit according to resistance ratio of the first resistor and the second resistor.

6. The low power consumption backup power system of claim 1 further including a boost circuit connected to the first power supply circuit and the second power supply circuit, the boost circuit including a charge/discharge circuit to get the first output power or the second output power, a boost switch connected to the charge/discharge circuit, a boost control unit to determine ON period of the boost switch to control charge timing of the second output power to the charge/discharge circuit to generate a boost power, and a power output terminal to output the first output power or the boost power.

7. The low power consumption backup power system of claim 6, wherein voltage of the boost power is equal to that of the first output power.

8. The low power consumption backup power system of claim 6, wherein the boost circuit includes a control switch located between the charge/discharge circuit and the power output terminal and electrically connected to the boost control unit.

9. The low power consumption backup power system of claim 8, wherein the boost control unit gets a detection signal from the first power supply circuit to control ON/OFF of the boost switch and the control switch, and determine whether to allow the first output power to directly pass through the boost circuit and output via the power output terminal, or allow the second output power to be boosted via the charge/discharge circuit to become the boost power and output through the power output terminal.

10. The low power consumption backup power system of claim 6, wherein the charge/discharge circuit includes an energy storage inductor, a diode and an energy storage capacitor.

11. The low power consumption backup power system of claim 1, wherein voltage of the first output power is higher than that of the second output power.

12. The low power consumption backup power system of claim 1, wherein the converted power of the power conversion unit is DC power.

13. The low power consumption backup power system of claim 1, wherein the power conversion unit includes a rectification filter unit connected to the external power input source, a power factor correction unit connected to the rectification filter unit, a transformer, a pulse width control unit, a switch element and a rectification output unit.

14. The low power consumption backup power system of claim 1, wherein the energy storage unit is a rechargeable battery.
